(19) United States
(12) Patent Application Publication
(10) Pub. No.: US 2016/0286853 A1
(43) Pub. Date: Oct. 6, 2016

(54) PROCESS FOR THE PRODUCTION OF AN AT LEAST TWO-LAYER FOIL

(71) Applicant: B.V. Deli-HTL Tabak Maatschappij, EINDHOVEN (NL)

(72) Inventor: Steven Dirk Wijers, Waalre (NL)

(73) Assignee: B.V. Deli-HTL Tabak Maatschappij, EINDHOVEN (NL)

(21) Appl. No.: 15/084,845

(22) Filed: Mar. 30, 2016

(30) Foreign Application Priority Data
Mar. 31, 2015 (NL) 2014556

(51) Int. Cl. A24D 1/02; B05D 7/00; A24B 3/14; B05D 3/00

(52) U.S. Cl. CPC A24D 1/02; B05D 3/007; B05D 7/50; A24B 3/14

(57) ABSTRACT

The present invention relates to a method for manufacturing a film consisting of at least two layers, the method comprising the following steps of:
i) arranging a first, still liquid bottom layer on an endless belt,
ii) arranging a second, still liquid top layer on the still liquid bottom layer obtained according to step i), after which the composition of bottom layer and top layer is subjected to a drying treatment for the purpose of obtaining said film consisting of at least two layers.

The present invention relates to a method for manufacturing a film consisting of at least two layers. The present invention further relates to an outer cover or wrapper for smoking products which comprises a film consisting of at least two layers.

U.S. Pat. No. 4,497,331 relates to a tobacco laminate for applying as a tobacco filler for cigarettes and cigars, wherein the tobacco laminate consists of two layers of reconstituted tobacco sheet material, wherein the layers are attached to each other in particular areas. The method for manufacturing such a tobacco laminate comprises the step of applying a tobacco slurry to a supporting surface, a step of drying the thus applied tobacco slurry, subsequently removing the resulting dried tobacco sheet from the supporting surface and finally laminating together pairs of thus dried tobacco sheets having spaced localized bonded and unbonded areas.

US patent application US 2004/0094172 relates to a method for manufacturing a cigarette with an improved burn behaviour, this method comprising of feeding a first strip of paper from a first bobbin of an outer wrap material to a cigarette making station, feeding a second strip of paper from a second bobbin of an inner wrap material to a cigarette making station, wherein the first strip of paper has a width of 19-29 mm and the second strip of paper has a width of less than 15 mm, joining the first strip of paper and the second strip of paper, wherein the first strip of paper lies under the second strip of paper so as to form a combined partial double wrap paper, arranging tobacco onto said double wrap paper, and finally folding the double wrap paper around said tobacco to form a cigarette cylinder.

U.S. Pat. No. 4,681,126 relates to a method wherein a sheet is obtained for applying as an outer cover or wrapper for smoking products. According to this American document, fibres are thus first arranged in a substantially dry form on a mesh belt, after which a binder solution is applied to the dry fibres lying on the conveyor belt, following which the binder is then dried and the sheet is removed from the conveyor belt so as to be applied in tobacco smoking articles. Example 7 of this American patent further states that it is possible to apply a further layer of dry fibres to the previously obtained sheet, after which the fibres are distributed using an airflow and a binder solution is again applied via spraying, following which the whole is dried so as to obtain a so-called laminated sheet. It is thus known from this US patent to manufacture a laminated sheet on the basis of dry fibres wherein the binder solution is then applied thereto in each case in a separate step by means of spraying.

U.S. Pat. No. 3,076,729 relates to a method for manufacturing a tobacco film wherein a slurry of tobacco particles from stems or from all parts of leaves is heated in water, after which the obtained slurry is arranged in accordance with a usual paper preparation method by water removal on a screen and dried so as to obtain a so-called self-supporting sheet. Known from this US patent is a method wherein, after drying of the pulp, a coating of ethyl cellulose and polypropylene glycol is applied by atomizing to the thus dried material via very fine spraying, after which the solvent is immediately evaporated by the heat still present in the warm conveyor belt, wherein the thus covered sheet is conditioned by steam and removed from the belt and wound up.

U.S. Pat. No. 4,306,578 relates to a method for manufacturing a tobacco sheet, wherein dry comminuted tobacco is combined with a base web composition comprising an aqueous slurry consisting essentially of an adhesive for this tobacco and cellulose fibres to form a castable composition which is subsequently cast as a thin sheet, and then dried.

Known from the European patent EP 1 489 927 (corresponding to WO 03082030) in the name of the present applicant is a method for manufacturing a tobacco sheet with a top layer of tobacco powder, wherein a base layer is composed on the basis of a fine fraction of tobacco and cellulose fibres, which base layer is provided on one side with a fraction of coarse tobacco, after which the whole is subjected to a drying treatment.

International application WO 2007007268 relates to a method for reconstituting powders of vegetal origin, such as residual powders from the tobacco industry, comprising the following steps of: acquiring the residual powders; composing a mixture of the residual powders with an agglutinant compound and water, laminating the obtained mixture to obtain a pellicle of the desired thickness, drying the pellicle and finally cutting the pellicle to obtain a product as fragments of the desired size.

According to the slurry process applied in the preparation of tobacco films a number of separate steps take place, viz. mixing tobacco materials ground to powder with water and binder. The thus obtained slurry, optionally supplemented with other ingredients and fibres, which can be wood fibres or from tobacco stems, is subsequently arranged on an endless conveyor belt and heated in order to remove the water that is present.

The present inventors have found that, when a film is composed of at least two layers, it is possible to attribute particular properties to the individual layers in the film. The present inventors have thus found that it is possible to functionalize one or more layers of said film, this meaning that particular properties can be imparted to specific individual layers.

The present inventors have further found that, in order to manufacture a film consisting of at least two different layers, it is possible to concentrate specific components of the starting material in a specific layer, whereby particular properties are obtained. Such properties differ essentially from the properties of a film consisting of only one layer prepared from exactly the same composition.

The present invention therefore relates to a method for manufacturing a film consisting of at least two layers, the method comprising the following steps of:

i) arranging a first, still liquid bottom layer on an endless belt,

ii) arranging a second, still liquid top layer on the still liquid bottom layer obtained according to step i), after which the composition of bottom layer and top layer is subjected to a drying treatment for the purpose of obtaining said film consisting of at least two layers.

The present inventors have found that one or more objectives can be fulfilled by applying such a method.

In a particular embodiment it is particularly desirable that step i) is performed by applying a coating member of the knife type, in particular that step ii) is performed by applying a coating member of the knife type. Surprisingly, the use of such a coating member has resulted in an embodiment wherein not only a particular, specific layer thickness of the separate layers can be realized, but wherein a certain “order” can moreover possibly be realized of the components present in such a layer. If a layer which is still liquid is arranged on the endless belt, after which the thus arranged liquid layer is levelled by applying the coating member of the knife type, the present inventors have found, particularly when such a layer comprises fibres, that such fibres then lie closely together. Although the present inventors are not bound to any theory, it is assumed that in such a situation the fibres apparently have a better interaction and will possibly be ordered in a specific direction. Such an ordering of fibres can possibly result in a positive effect on the mechanical properties, in particular the tensile strength of such a thus obtained film. The desired properties of the first layer thus arranged on the endless belt are retained when a second, still liquid top layer is arranged on the still liquid bottom layer obtained according to step i). In addition to use of the above stated coating member of the knife type, it is also possible in specific embodiments, in particular for performing step i), to apply a so-called reversed roll coater, wherein the slurry is applied to the endless belt in the desired layer thickness using rotating rollers.

Because liquid layers are arranged in the present method wherein it is desirable that such liquid layers are mixed together as little as possible, it is particularly recommended that the flow behaviour of the bottom layer to be arranged in step i) differs from the flow behaviour of the top layer to be arranged in step ii), wherein the flow behaviour is determined by applying a Bostwick Consistometer (procedures in accordance with Mill Spec R-81294D and ASTM F1080-93). It is desirable here that the bottom layer to be arranged flows less easily than the top layer to be arranged in step ii).

When there is such a difference in flow behaviour in the mutually adjacent layers, the present inventors have found that little or substantially no mixing of the above stated layers occurs. If the film to be manufactured consists of for instance three layers, it is then desirable that the bottom layer flows less easily than the intermediate layer adjacent thereto, which intermediate layer in turn also flows less easily than the third layer lying thereon. It has thus been found desirable that the flow behaviour of the layers in the direction from the bottom layer to the top layer is such that the layers flow increasingly more easily, wherein the bottom layer is seen as the layer arranged first in a liquid state on the endless belt.

In a particular embodiment it is desirable that the layer thickness of the bottom layer to be arranged in step i) is smaller than the layer thickness of the top layer to be arranged in step ii). The present inventors have found that the bottom layer will serve in many embodiments as a certain carrier layer and thus impart strength to the final film. One or more particular properties can thus be incorporated in the one or more top layers arranged on the bottom layer without immediate allowance having to be made for the influence on the mechanical properties thereof on the overall finally obtained composition of layers. In another embodiment it is also possible for the layer thickness of the bottom layer to be arranged in step i) to be greater than the layer thickness of the top layer to be arranged in step ii).

Mentioned as particular properties which can be attributed to the one or more top layers lying on the bottom layer are: colour, structure, in particular the smoothness or roughness, consistency, flavour, porosity, resistance to water, resistance to heat, barrier-forming.

The present inventors have thus found that it is possible to manufacture a film of for instance four layers, wherein the bottom layer serves particularly to impart strength and flexibility, the second layer lying thereon serves as flavouring layer (for instance a dark-coloured, dark-flavoured cigar tobacco), the third layer serves substantially as a tobacco layer of light colour, which third layer serves in fact as visible side of the product, after which the package of layers is closed with a fourth layer on the basis of alginate, and is thus translucent as well as transparent and water-resistant.

It is thus possible in the present method that, after said top layer has been arranged, one or more further liquid layers are arranged on the already obtained composition before the above stated drying treatment is performed.

Because a film consisting of at least two layers is manufactured according to the present invention, it is desirable in specific embodiments that the compositions of each of the layers to be arranged differ from each other. This means that the layers acquire specific properties in order to thus achieve an optimized and functionalized film.

According to the above discussed prior art, use is usually made of a spraying process to apply binder. It is however desirable according to the present invention that performing of step i) and step ii) does not take place by spraying or atomizing the starting materials applied for the purpose of obtaining the respective layers. It is however possible in a specific embodiment for the final layer of the composition of layers to be arranged by means of spraying, sprinkling or atomizing.

In a particular embodiment it is desirable that the weight per unit of area of the bottom layer to be arranged in step i) is less than the weight per unit of area of the top layer to be arranged in step ii).

The present invention relates particularly to a method for manufacturing a film consisting of at least two layers wherein said film consisting of at least two layers is a reconstituted wrapper or outer cover for smoking products.

Particularly for the purpose of imparting mechanical properties to the bottom layer, wherein tensile strength as well as flexibility at low moisture contents should be particularly envisaged, it is desirable in a specific embodiment that step i) and step ii) are performed such that the quantity of fibres of vegetable origin in the bottom layer arranged in step i) is greater than the quantity of fibres of vegetable origin in the top layer arranged in step ii). The present inventors have found that, surprisingly, the physical properties of a layer with concentrated fibres differ from those of the same quantity of fibres per square metre when such fibres are distributed over the total layer thickness of a usual prior art film. The present inventors have found that a usual prior art film loses integrity (becomes brittle) below a moisture content of 11%, while the fibre layer obtained according to the present method certainly displays a flexible character to a moisture content of 5%. This favourable effect is largely retained when a top layer substantially of tobacco is arranged on the present fibre layer.

The present inventors have further found that in such an embodiment it is particularly recommended that the quantity of fibres of vegetable origin of the top layer arranged in step ii) amounts to a maximum of 20% by weight, preferably a maximum of 10% by weight, and in particular preference a maximum of 5% by weight, on the basis of the total weight of the top layer arranged in step ii).

It has further been found that it is further recommended in such an embodiment for the quantity of binder in the bottom layer arranged in step i) to be greater than the quantity of binder in the top layer arranged in step ii). It should be stated here that the quantity of binder in the top layer arranged in step ii) is limited to the minimum quantity of binder required to obtain a consistent and adhering top layer. It is thus recommended that the quantity of binder in the top layer arranged in step ii) amounts to a maximum of 20% by weight, preferably a maximum of 10% by weight, in particular preference a maximum of 5% by weight, on the basis of the total weight of the top layer arranged in step ii).

As a particular embodiment for functionalizing the layers applied in the film, the present inventors have found that the present method is specifically not limited to particular fibres of vegetable origin but that glass fibre, fibres of animal origin and synthetic fibres, such as for instance nylon, can for instance be mentioned as possible suitable fibres.

The binders applied in the present invention are for instance selected from the group of methyl cellulose, ethyl cellulose, hydroxypropyl cellulose, methyl hyd roxyethyl cellulose, ethylhydroxyethyl cellulose, cellulose acetate, hydroxyethyl cellulose, sodium carboxymethyl cellulose, natural vegetable gum materials, in particular gum arabic, gum tragacanth, guar gum and locust bean gum, alginic acid and alginates, carageenan and agar, and mixtures of the above binders.

The present invention further relates to an outer cover or wrapper for smoking products, comprising a film consisting of at least two layers, wherein the quantity of fibres of vegetable origin present in the bottom layer of said film is greater than the quantity of fibres of vegetable origin present in the top layer of said film.

On the basis of the present method the present inventors have found that it is possible, as a result of the use of different layers, to combine different properties at the same moment in the same end product. In the embodiment of outer cover or wrapper for smoking products the inventors state that it is typical for tobacco that colour and flavour are related to each other. A light-coloured tobacco (such as Virginia) thus provides a “bright” character, wherein a dark-coloured tobacco has a certain “dark” character. It is therefore desirable that the tobacco to be applied in step i) is of the dark-coloured type, in particular dark air cured and/or fire cured Kentucky, and that the tobacco to be applied in step ii) is of the light-coloured type, in particular flue cured Virginia and/or Turkish.

The present inventors have found that it is possible, without adversely affecting the technical properties of the film, to manufacture a film consisting of two layers wherein the bottom layer is composed on the basis of dark tobacco, wherein the top layer is composed on the basis of light tobacco. When for instance 80% of the total film is the bottom layer, the final end product will then have a dark flavour but a somewhat light colour because of the light-coloured tobacco in the top layer. In for instance a film consisting of three layers it has thus been found possible to embody both the bottom layer and the outer top layer in a lighter form than the middle dark layer.

The present inventors have further found that it is possible by applying the present method to manufacture an outer cover from two layers, wherein watertightness is realized only in the top layer by applying so-called cross-linkers only in the top layer.

The present invention will be elucidated hereinbelow on the basis of a number of examples and comparative examples, wherein it should however be noted that the present invention is in no way limited to such particular examples.

In the examples the term “100 μm tobacco” relates to a tobacco powder obtained by grinding and subsequent screening of coarser tobacco, wherein the fraction which passes through a screen with mesh width 100 μm is collected as desired product.

The terms “SR90, SR40 etc.” relate to the Schoppen Riegler method for determining the freeness of cellulose pulp. SR90 thus represents a Schoppen Riegler freeness here of 90°.

The viscosity measurements were performed with a Brookfield rotational viscometer RVT. Measurement took place with spindle 5 at 20 revolutions per minute. The temperature of the measurement is shown in all cases. Where reference is made to viscosity, this is understood to mean the result of this measurement.

The consistency was determined with a Bostwick consistometer.

### EXAMPLE 1

Preparation of Mixture 1

10 g of guar gum, 85 g of finely ground tobacco 100 μm of a light colour (Virginia tobacco), 5 g of glycerin and 650 ml of demineralized water at 60° C. were mixed in a glass beaker. These components were mixed with a usual laboratory agitator until a visually homogenous mass was obtained. This mixture was placed on a water bath at a temperature of 60° C. The viscosity of the thus obtained mixture amounted to 62000 cps (at 60° C.). The Bostwick consistency amounted to 4.7.

Preparation of Mixture 2

20 g of methyl cellulose, 80 g of 100 μm tobacco of a clearly darker colour than the tobacco used in mixture 1 (dark air cured tobacco) and 900 ml of demineralized water at 20° C. were mixed in a second glass beaker. After mixing of these components as described for mixture 1, a mixture was obtained with a viscosity of 11500 cps at 20° C. The Bostwick consistency amounted to 7.9.

Manufacture of Two-Layer Product

A layer of mixture 1 with a thickness of 0.6 mm was applied first to a clean and dry glass plate using a wet-film applicator. Immediately thereafter a wet-film applicator with gap size of 1.2 mm was then used. Mixture 2 was spread therewith over mixture 1. The glass plate with the thus obtained composition of mixtures was transferred to a water bath set to 90° C. and dried. After drying the sheet was removed from the glass plate.

The inventors report that when the second layer was arranged there was no discernible mixing with the first layer. A product was thus obtained after drying consisting of two layers connected non-releasably to each other.

### COMPARATIVE EXAMPLE 1

The operations and preparation of the two mixtures 1 and 2 described in example 1 were repeated, except that now mixture 2 was applied first to a clean and dry glass plate, followed by mixture 1. It was found to be not possible to arrange mixture 1 over mixture 2. Mixture 2 mixed partially with mixture 1 and was partially removed from the glass plate by mixture 1.

### EXAMPLE 2

Similarly to example 1 two separate mixtures were prepared, except that a quantity of 1 g of calcium chloride was however added to mixture 1. The viscosity and consistency of the thus obtained mixture were substantially the same as those of the mixture of example 1.

In example 2 mixture 2 was a solution of sodium alginate in demineralized water with a solid content of 2%. The viscosity of this mixture amounted to 13000 cps (temperature 20° C.). The Bostwick consistency amounted to 12.3.

According to the same method as in example 1, both the above mixtures were arranged in two layers, viz. first a layer of mixture 1 and then a layer of mixture 2, over each other on a glass plate and subsequently dried.

It could now also be seen that, when mixture 2 was arranged over mixture 1, the layers did not mix with each other, or hardly so. It is a known phenomenon that sodium alginate in contact with calcium ions becomes insoluble in water. This effect occurs in this example 2 because the alginate of mixture 2 reacts with the dissolved calcium in mixture 1.

Obtained after drying was a tobacco film consisting of two layers comprising a tobacco layer with a layer of water-insoluble alginate connected non-releasably thereto. When this composite product was soaked in water, the tobacco layer dissolved again, but a transparent film of alginate remained. The water-soluble tobacco film is thus provided with a water-resistant protective layer on the basis of alginate.

### COMPARATIVE EXAMPLE 2

As additional experiment mixture 1 was mixed with mixture 2 in the composition as described above in example 2. The same ratio was applied here as the ratio of the wet layer thicknesses of example 2. The result of said mixing was that water-insoluble lumps of alginate immediately occurred with which a homogenous film could not be obtained.

### COMPARATIVE EXAMPLE 3

The preparation of the two mixtures 1 and 2 described in example 1 was repeated, except that now mixture 2 was arranged first on a clean and dry glass plate, followed by mixture 1. It was found in this embodiment to be not possible to obtain a tobacco film consisting of two separate layers.

### EXAMPLE 3

On a production line for wrapper and outer cover for cigars wherein operation took place according to the slurry process, at a distance of about 1 metre from a coating member of the knife type a second knife of the same type was placed positioned in the direction of travel of the belt and upstream of the point at which the drying begins. A mixture 1 was prepared consisting of cellulose and binder. Mixture 2 comprised tobacco powder, binder and softener. The exact composition is shown in the table below.

Making use of the above configuration in a continuous process the layer of mixture 1 was first arranged on the belt. This resulted in a layer of 10 g/m² with a tensile strength of 750 N/m at a moisture content of 5%. The composition of this layer is shown in the table as bottom layer. The application of the second layer was then also started in accordance with the present invention, wherein mixture 2 was thus applied in the wet phase over the first layer. A film consisting of two layers, viz. a bottom layer and top layer, was hereby produced in a continuous process.

The present inventors have also found that, surprisingly, the film consisting of two layers, which has the same overall composition as the “complete” formulation in the table, does not become brittle when dried in air. The obtained film product consisting of two layers was found to have a tensile strength of 500 N/m at 5% moisture. If the same product is produced as a homogenous film, viz. on the basis of the “complete” formulation, this film then becomes breakable when dried in air and it has not been found possible to measure the tensile strength thereof or to further process the product.

| | | | | | BOTTOM | |
|---|---|---|---|---|---|---|
| | COMPLETE | | TOP LAYER | | LAYER | |
| | kg | % | kg | % | kg | % |
| Tobacco powder | 104.00 | 67% | 104.00 | 84.8% | | |
| Cellulose fibres | 22.20 | 14% | | | 22.20 | 66.9% |
| (paper pulp) | | | | | | |
| Methyl cellulose | 26.50 | 17% | 15.50 | 12.6% | 11 | 33.1% |
| (binder) | | | | | | |
| Propylene glycol | 3.20 | 2% | 3.20 | 2.6% | | |
| (plasticizer) | | | | | | |
| kg total | 155.90 | --> | 122.70 | + | 33.20 | |
| DS | 8.9% | | 12.0% | | 4.5% | |
| Water | 1600 | --> | 900 | + | 700 | |
| Sheet weight | 50 | | 39.4 | | 11 | |
| (dry, g/m²) | | | | | | |

It follows from the above table that ‘dividing’ the initial composition into a top layer and a bottom layer, which division falls within the scope of protection of the present invention, has resulted in a film which consists of two layers and the tensile strength of which is higher than the film consisting of one layer.

The present inventors have further found that the film consisting of a top layer and a bottom layer is less susceptible to dessication than the single-layer film.

1. A method for manufacturing a film comprising at least two layers, the method comprising the following steps of:
i) arranging a first, still liquid bottom layer on an endless belt,
ii) arranging a second, still liquid top layer on the still liquid bottom layer obtained according to step i), after which the composition of bottom layer and top layer is subjected to a drying treatment for obtaining said film comprising at least two layers.

2. The method according to claim 1, wherein step i) is performed by applying the first, still liquid bottom layer and the second, still liquid top layer by a coating member of the knife type or a reversed roll coater.

3. The method according to claim 1, wherein step ii) is performed by applying by coating member of the knife type.

4. The method according to claim 1 wherein the flow behavior of the bottom layer to be arranged in step i) is higher than the flow behavior of the top layer to be arranged in step ii), wherein the flow behavior is determined by applying a Bostwick Consistometer according to procedures in accordance with Mill Spec R-81294D or ASTM F1080-93.

5. The method according to claim 1 wherein the layer thickness of the bottom layer to be arranged in step i) is than the layer thickness of the top layer to be arranged in step ii).

6. The method according to claim 1 wherein after said top layer has been arranged, one or more further liquid layers are arranged on the already obtained composition before said drying treatment is performed.

7. The method according to claim 1 wherein the compositions of each of the layers to be arranged differ from each other.

8. The method according to claim 1 wherein performing of step i) and step ii) does not take place by spraying or atomizing the starting materials applied for the purpose of obtaining the respective layers.

9. The method according to claim 1 wherein the weight per unit of area of the bottom layer to be arranged in step i) is less than the weight per unit of area of the top layer to be arranged in step ii).

10. The method according to claim 1 wherein said film comprising at least two layers is a wrapper or outer cover for smoking products.

11. The method according to claim 10, wherein step i) and step ii) are performed such that a quantity of fibers of vegetable origin in the bottom layer arranged in step i) is greater than a quantity of fibers of vegetable origin in the top layer arranged in step ii).

12. The method according to claim 11, wherein the quantity of fibers of vegetable origin of the top layer arranged in step ii) amounts to a maximum of 20% by weight on the basis of the total weight of the top layer arranged in step ii).

13. The method according to claim 10 wherein a quantity of binder in the bottom layer arranged in step i) is greater than the a quantity of binder in the top layer arranged in step ii).

14. The method according to claim 13, wherein the quantity of binder in the top layer arranged in step ii) amounts to a maximum of 20% by weight by weight, on the basis of the total weight of the top layer arranged in step ii).

15. The method according to claim 1 wherein tobacco is applied in step i) which is of the dark-colored type, and tobacco is applied in step ii) which is of the light-colored type.

16. The method according to claim 13 wherein the binders are selected from methyl cellulose, ethyl cellulose, hydroxypropyl cellulose, methylhydroxyethyl cellulose, ethylhydroxyethyl cellulose, cellulose acetate, hydroxyethyl cellulose, sodium carboxymethyl cellulose, natural vegetable gum materials, in particular gum arabic, gum tragacanth, guar gum and locust bean gum, alginic acid and alginates, carageenan and agar, and mixtures of said binders.

17. An outer cover or wrapper for smoking products, comprising a film comprising at least two layers, wherein a quantity of fibers of vegetable origin present in a bottom layer of said film is greater than a quantity of fibers of vegetable origin present in a top layer of said film.
